(19) United States
(12) Patent Application Publication
(10) Pub. No.: US 2012/0132349 A1
(43) Pub. Date: May 31, 2012

(54) METHOD FOR PRODUCING TUNABLE INTERFERENCE FILTER

(75) Inventors: Yasushi MATSUNO, Matsumoto (JP); Koji KITAHARA, Ina (JP); Hiroshi KOMATSU, Shimosuwa (JP)

(73) Assignee: SEIKO EPSON CORPORATION, Tokyo (JP)

(21) Appl. No.: 13/301,161

(22) Filed: Nov. 21, 2011

(30) Foreign Application Priority Data
Nov. 26, 2010 (JP) 2010-263249

(51) Int. Cl. B32B 37/02; B32B 37/06; B32B 37/08; B32B 37/14

(52) U.S. Cl. 156/182

(57) ABSTRACT

A method for producing a tunable interference filter including a first substrate, a second substrate, a first reflection coating, a second reflection coating, and a gap changing section having a first gap changing section and a second first gap changing section, the method comprising a first substrate production process of forming the first substrate and forming the first reflection coating and the first gap changing section on the first substrate, a second substrate production process of forming the second substrate and forming the second reflection coating and the second gap changing section on the second substrate, and a bonding process of bonding the first substrate and the second substrate in a state in which temperature of the first substrate is higher than temperature of the second substrate after the first substrate production process and the second substrate production process.

### BACKGROUND

1. Technical Field

The present invention relates to a method for producing a tunable interference filter.

2. Related Art

In the past, a tunable interference filter that emits a light with an intended wavelength by multiple interference of a light between a pair of reflection coatings has been known (see, for example, JP-A-2009-251105 (Patent Document 1)).

An optical filter apparatus (a tunable interference filter) described in Patent Document 1 has a first substrate and a second substrate which are disposed so as to face each other, and, on each of surfaces of the first substrate and the second substrate, the surfaces facing each other, a movable mirror and a fixed mirror are provided.

Moreover, in the first substrate, the movable mirror is provided in a first portion (a movable section) in the center of the substrate, and, at the periphery of the first portion, a second portion (a supporting section) whose thickness is less than the thickness of the first portion, the second portion having flexibility, is provided. On a surface of the first substrate in the second portion, the surface facing the second substrate, a first electrode (a movable electrode) is provided, and, on a surface of the second substrate, the surface facing the first electrode, a second electrode (a fixed electrode) disposed so as to face the first electrode at a predetermined distance from the first electrode is provided.

In such a tunable interference filter, when a voltage is applied between the first electrode and the second electrode, the second portion of the first substrate bends toward the second substrate by electrostatic attraction, and a gap size between the movable mirror and the fixed mirror changes. As a result, the tunable interference filter can extract, from an incident light, a light with a wavelength according to the gap size between the mirrors by controlling the voltage between the first electrode and the second electrode.

Incidentally, in the tunable interference filter described in Patent Document 1 mentioned above, the first electrode is formed in the second portion of the first substrate, and the movable mirror is formed in the first portion of the first substrate.

Such first electrode and movable mirror are each formed as a film on the first substrate. When a film is formed, internal stress acts in a direction of a plane of the film (a direction along a substrate surface of the first substrate). The direction and magnitude of the internal stress are determined by a film formation method, film material, etc. When the internal stress acts in a direction toward the center of the film, the internal stress becomes compressive stress, and, when the internal stress acts outward from the center of the film on the first electrode, the internal stress becomes tensile stress. Here, when the compressive stress acts on the film formed on the first substrate, the first substrate bends toward the second substrate, and, when the tensile stress acts on the film formed on the first substrate, the first substrate bends in such away so as to move away from the second substrate.

As described above, when the first substrate bends due to the internal stress of the film, the film of the movable mirror also bends according to bending of the substrate. As a result, in an initial state in which no drive voltage is applied between the first electrode and the second electrode, there may be cases where the film of the movable mirror and the film of the fixed mirror cannot be kept in a state in which they are parallel to each other, leading to a reduction in resolution of the tunable interference filter. Moreover, the first substrate sometimes bends due to a change in the environmental temperature.

### SUMMARY

An advantage of some aspects of the invention is to provide a method for producing a tunable interference filter in which bending of a substrate is reduced.

An aspect of the invention is directed to a method for producing a tunable interference filter including a first substrate, a second substrate facing the first substrate, a first reflection coating provided on a surface of the first substrate, the surface facing the second substrate, a second reflection coating provided on a surface of the second substrate, the surface facing the first substrate, the second reflection coating facing the first reflection coating with a gap between the second reflection coating and the first reflection coating, and a gap changing section that can change the size of the gap, the first substrate having a movable section on which the first reflection coating is provided and a holding section formed so as to have a thickness less than the thickness of the movable section, the holding section holding the movable section in such a way that the movable section can move with respect to the second substrate, the method including: a first substrate production process of forming the first substrate and forming the first reflection coating and the gap changing section on the first substrate; a second substrate production process of forming the second substrate and forming the second reflection coating and the gap changing section on the second substrate; and a bonding process of bonding the first substrate and the second substrate in a state in which the temperature of the first substrate is higher than the temperature of the second substrate after the first substrate production process and the second substrate production process.

In the first substrate production process, the first substrate having the supporting section formed so as to have a thickness less than the thickness of the movable section is formed, and the first reflection coating and the gap changing section are provided on the first substrate. After the first substrate production process, the first substrate is in a bent state due to the internal stress of the first reflection coating and the gap changing section.

Then, in the bonding process, the first substrate and the second substrate are bonded together in a state in which the temperature of the first substrate is higher than the temperature of the second substrate by heating the first substrate and keeping the second substrate at room temperature, for example.

In this case, the first substrate is bonded to the second substrate in a state in which the first substrate expands in a direction along the substrate surface. After the first substrate and the second substrate are bonded together, when the temperature of the first substrate is restored to room temperature, the first substrate is about to contract in a direction along the substrate surface. However, since the first substrate is bonded to the second substrate, the first substrate cannot contract in a direction along the substrate surface and is pulled in a direction along the substrate surface, whereby bending thereof is reduced. As a result, a tunable interference filter in which bending of the first substrate is reduced is obtained.

Incidentally, the thickness of the first substrate and the thickness of the second substrate in the invention refer to the size of a portion in which the thickness of each substrate becomes maximum.

It is preferable that, in the method for producing a tunable interference filter according to the aspect of the invention, the bonding process be carried out in a state in which the first substrate is being heated and the second substrate is kept at room temperature.

In the aspect of the invention, since a method by which the first substrate which is being heated and the second substrate which is kept at room temperature are bonded together is adopted, it is possible to make the first substrate expand easily and bring about easily a state in which bending of the first substrate is reduced after the first substrate and the second substrate are bonded together. Moreover, according to the aspect of the invention, as compared to a method by which the first substrate is kept at room temperature and the second substrate is cooled, it is easier to bring about a state in which the temperature of the first substrate is higher than the temperature of the second substrate. This makes it possible to simplify the facilities to produce the tunable interference filter.

In the method for producing a tunable interference filter according to the aspect of the invention, it is preferable that the thickness of the second substrate be greater than the thickness of the first substrate.

In the aspect of the invention, by increasing the thickness of the second substrate, the stiffness of the second substrate is increased. Therefore, when a method by which the first substrate which is being heated and the second substrate which is kept at room temperature are bonded together is adopted, it is possible to prevent the second substrate from being warped by the force by which the first substrate contracts in a direction along the substrate surface after the first substrate and the second substrate are bonded together. Moreover, when a method by which the first substrate is kept at room temperature and the second substrate is cooled is adopted, it is possible to pull the first substrate in a direction along the substrate surface by the force by which the second substrate expands in a direction along the substrate surface after the first substrate and the second substrate are bonded together. This makes it possible to reduce bending of the first substrate.

### BRIEF DESCRIPTION OF THE DRAWINGS

The invention will be described with reference to the accompanying drawings, wherein like numbers reference like elements.

FIG. 1 is a plan view showing a schematic configuration of an etalon of a first embodiment according to the invention.

FIG. 2 is a sectional view showing a schematic configuration of the etalon of the first embodiment.

FIGS. 3A to 3D are diagrams showing the process for production of a first substrate of the etalon of the first embodiment.

FIGS. 4A to 4C are diagrams showing the process for production of a second substrate of the etalon of the first embodiment.

FIG. 5 is a diagram showing a process for bonding the etalon of the first embodiment.

### DESCRIPTION OF EXEMPLARY EMBODIMENTS

### First Embodiment

Hereinafter, a first embodiment according to the invention will be described based on the drawings.

### 1. Configuration of an Etalon

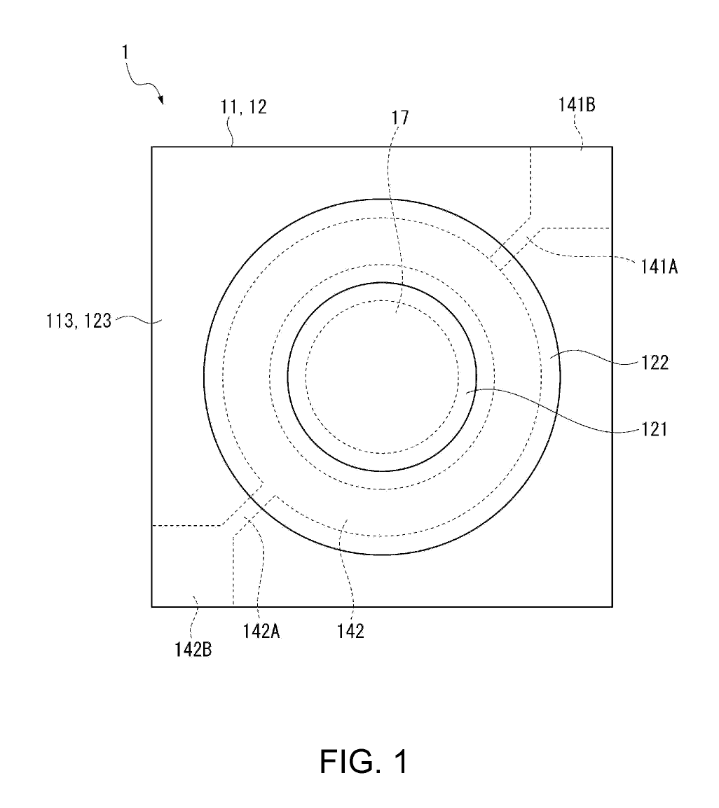

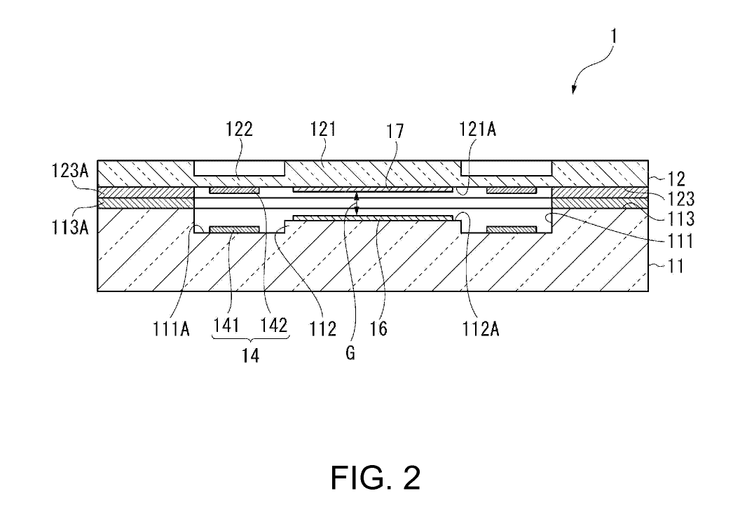

FIG. 1 is a plan view showing a schematic configuration of an etalon 1 forming a tunable interference filter according to the embodiment of the invention. FIG. 2 is a sectional view showing a schematic configuration of the etalon 1.

As shown in FIG. 1, the etalon 1 is an optical element in the form of a plate which is square in a plan view, the optical element which is 10 mm, for example, per side. As shown in FIG. 2, the etalon 1 includes a movable substrate 12 which is a first substrate according to the embodiment of the invention and a fixed substrate 11 which is a second substrate according to an aspect of the invention. The two substrates 11 and 12 are formed of various kinds of glass such as soda glass, crystalline glass, silica glass, lead glass, potassium glass, borosilicate glass, and no alkali glass and quartz or the like. The two substrates 11 and 12 are integrally formed as a result of bonding sections 113 and 123 which are formed near the periphery being bonded together.

As a bonding method, there are (cold) activated bonding, siloxane bonding using a plasma-polymerized film, bonding by using an adhesive, and anode bonding, for example.

On the fixed substrate 11, a fixed reflection coating forming a second reflection coating according to the embodiment of the invention is provided, and, on the movable substrate 12, a movable reflection coating 17 forming a first reflection coating according to the embodiment of the invention is provided. Here, the fixed reflection coating 16 is fixed to a surface of the fixed substrate 11, the surface facing the movable substrate 12, and the movable reflection coating 17 is fixed to a surface of the movable substrate 12, the surface facing the fixed substrate 11. Moreover, the fixed reflection coating 16 and the movable reflection coating 17 are disposed so as to face each other with a gap G between them.

Furthermore, between the fixed substrate 11 and the movable substrate 12, an electrostatic actuator 14 as a gap changing section is provided. The electrostatic actuator 14 adjusts the size of the gap G between the fixed reflection coating 16 and the movable reflection coating 17, and includes a fixed electrode 141 provided on a side of the fixed substrate 11 and a movable electrode 142 provided on a side of the movable substrate 12. ps 1-1. Configuration of a Fixed Substrate

It is preferable that the thickness of the fixed substrate 11 be greater than the thickness of the movable substrate 12 and, more preferably, the thickness of the fixed substrate 11 be more than 1.5 times the thickness of the movable substrate 12. The fixed substrate 11 is formed by processing a glass base material formed so as to have a thickness of 500 μm, for example. Specifically, as shown in FIG. 2, in the fixed substrate 11, an electrode formation groove 111 and a reflection coating fixing section 112 are formed by etching. The fixed substrate 11 is formed so as to be thicker than the movable substrate 12, and the fixed substrate 11 does not bend due to the electrostatic attraction generated when a voltage is applied between the fixed electrode 141 and the movable electrode 142 and the internal stress of the fixed electrode 141.

The electrode formation groove 111 is formed so as to have a circular shape having a planar central point as the center thereof in a planar view (hereinafter referred to as an etalon planar view) in which the etalon 1 shown in FIG. 1 is seen from a thickness direction. In the planar view, the reflection coating fixing section 112 is formed so as to project toward the movable substrate 12 from the central portion of the electrode formation groove 111.

Moreover, in the fixed substrate 11, a pair of extraction formation grooves (not shown) which extend in directions of vertices on the outer edge of the fixed substrate 11 from the electrode formation groove 111 (for example, a direction to bottom left and a direction to top right in FIG. 1) are provided.

In addition, in an electrode fixing surface 111A which is a groove bottom of the electrode formation groove 111 of the fixed substrate 11, a ring-shaped fixed electrode 141 is formed. As a material forming the fixed electrode 141, it is necessary simply to use a conductive material. For example, metal such as Au, Al, and Cr and a transparent conductive oxide such as ITO can be used.

Moreover, a fixed extraction electrode 141A which extends from the outer edge of the fixed electrode 141 along the pair of extraction formation grooves (in FIG. 1, the direction to top right) is provided. The fixed extraction electrode 141A is formed concurrently with the film formation of the fixed electrode 141. At the tip of the fixed extraction electrode 141A, a fixed electrode pad 141B is formed, and the fixed electrode pad 141B is connected to a voltage control section (not shown). Incidentally, the voltage control section controls a voltage which is applied to the fixed electrode 141 and the movable electrode 142 of the electrostatic actuator 14.

As described earlier, the reflection coating fixing section 112 is formed into a cylindrical shape whose diameter is less than the diameter of the electrode formation groove 111 on the same axis as the electrode formation groove 111. Incidentally, in this embodiment, as shown in FIG. 2, an example in which a reflection coating fixing surface 112A of the reflection coating fixing section 112, the reflection coating fixing surface 112A facing the movable substrate 12, is formed so as to be closer to the movable substrate 12 than the electrode fixing surface 111A is shown; however, the invention is not limited thereto. The levels of the electrode fixing surface 111A and the reflection coating fixing surface 112A are appropriately set according to the size of the gap G between the fixed reflection coating 16 fixed to the reflection coating fixing surface 112A and the movable reflection coating 17 formed on the movable substrate 12, the distance between the fixed electrode 141 and the movable electrode 142, which will be described later, formed on the movable substrate 12, and the thicknesses of the fixed reflection coating 16 and the movable reflection coating 17. For example, when a dielectric multilayer is used as the reflection coatings 16 and 17 and the thicknesses thereof increase, a configuration in which the electrode fixing surface 111A and the reflection coating fixing surface 112A are formed on the same plane or a configuration in which a reflection coating fixing groove in the form of a cylindrical concave groove is formed in the central portion of the electrode fixing surface 111A, and the reflection coating fixing surface 112A is formed on the bottom of the reflection coating fixing groove may be adopted.

However, the electrostatic attraction which acts between the fixed electrode 141 and the movable electrode 142 is inversely proportional to the square of the distance between the fixed electrode 141 and the movable electrode 142. Therefore, as the fixed electrode 141 and the movable electrode 142 get closer to each other, the electrostatic attraction generated according to an applied voltage increases and the amount of change in the gap G increases. In particular, as in the etalon 1 of this embodiment, when the amount of change in the gap G is very small (for example, 250 to 450 nm), it becomes difficult to control the gap G. Therefore, even when the reflection coating fixing groove is formed as described above, it is preferable to secure the depth of the electrode formation groove 111 to some extent, and, in this embodiment, it is preferable that the electrode formation groove 111 be formed so as to have a depth of 1 μm, for example.

Moreover, for the reflection coating fixing surface 112A of the reflection coating fixing section 112, it is preferable that the depth of the groove be designed with consideration also given to a wavelength region that is made to pass through the etalon 1. For example, when an initial value of the gap G between the fixed reflection coating 16 and the movable reflection coating 17 (the size of the gap G in a state in which no voltage is applied between the fixed electrode 141 and the movable electrode 142) is set at 450 nm and settings are made such that the movable reflection coating 17 can be displaced until the size of the gap G becomes, for example, 250 nm by applying a voltage between the fixed electrode 141 and the movable electrode 142, the film thicknesses of the fixed reflection coating 16 and the movable reflection coating 17 and the levels of the reflection coating fixing surface 112A and the electrode fixing surface 111A simply have to be set at values at which the size of the gap G can be displaced in the 250- to 450-nm range.

In addition, to the reflection coating fixing surface 112A, the fixed reflection coating 16 which is formed so as to have a circular shape is fixed. The fixed reflection coating 16 may be formed as a metal single layer film, a dielectric multilayer, or a dielectric multilayer on which an Ag alloy is formed. As the metal single layer film, an Ag alloy single layer film, for example, can be used. When the fixed reflection coating 16 is formed as a dielectric multilayer, a dielectric multilayer formed of TiO₂ as a high-refractive layer and SiO₂ as a low-refractive layer, for example, can be used. Here, when the fixed reflection coating 16 is formed as a metal single layer film such as an Ag alloy single layer film, it is possible to form a reflection coating that can cover the entire visual light range as a wavelength region that can be dispersed by the etalon 1. Moreover, when the fixed reflection coating 16 is formed as a dielectric multilayer, although a wavelength region that can be dispersed by the etalon 1 is narrower than that of the Ag alloy single layer film, the dispersed light transmission is higher and the half-value width of the transmission is narrower, which makes it possible to achieve higher resolution.

Furthermore, the fixed substrate 11 has, on a lower surface on the side of the fixed substrate 11 opposite from an upper surface facing the movable substrate 12, an unillustrated anti-reflection coating (AR) formed in a position corresponding to the fixed reflection coating 16. The anti-reflection coating is formed by alternately stacking a low-refractive film and a high-refractive film, and decreases the visible light reflectivity of the surface of the fixed substrate 11 and increases the transmission.

### 1-2. Configuration of a Movable Substrate

The movable substrate 12 is formed by processing, by etching, a glass base material formed so as to have a thickness of 200 μm, for example.

Specifically, in the plan view shown in FIG. 1, the movable substrate 12 includes a circular movable section 121 having a substrate central point as the center thereof and a holding section 122 which is on the same axis as the movable section 121 and holds the movable section 121.

The movable section 121 is formed so as to be thicker than the holding section 122. For example, in this embodiment, the movable section 121 is formed so as to have a thickness of 200 μm, which is the same as the thickness of the movable substrate 12. Moreover, the movable section 121 includes a movable surface 121A which is parallel to the the reflection coating fixing section 112, and, to the movable surface 121A, the movable reflection coating 17 facing the fixed reflection coating 16 with the gap G between them is fixed.

Here, as the movable reflection coating 17, a reflection coating having the same configuration as the fixed reflection coating 16 described above is used.

Furthermore, the movable section 121 has, on an upper surface on the side of the movable section 121 opposite from the movable surface 121A, an unillustrated anti-reflection coating (AR) formed in a position corresponding to the movable reflection coating 17. The anti-reflection coating has the same configuration as the anti-reflection coating formed on the fixed substrate 11, and is formed by alternately stacking a low-refractive film and a high-refractive film.

The holding section 122 is a diaphragm surrounding the movable section 121. The holding section 122 is formed so as to have a thickness of 50 μm, for example, and have lower stiffness in the thickness direction than the movable section 121. As a result, the holding section 122 bends more easily than the movable section 121, and it is possible to bend the holding section 122 toward the fixed substrate 11 by weak electrostatic attraction. At this time, since the movable section 121 is thicker than the holding section 122 and has higher stiffness than the holding section 122, even when the force which bends the movable substrate 12 by electrostatic attraction acts thereon, the movable section 121 hardly bends, and it is possible to prevent bending of the movable reflection coating 17 formed in the movable section 121.

In addition, on a surface of the holding section 122, the surface facing the fixed substrate 11, the ring-shaped movable electrode 142 is formed. The movable electrode 142 faces the fixed electrode 141 with a gap of about 1 μm between them. Moreover, the movable electrode 142 is formed of the same material as the fixed electrode 141.

From part of the outer edge of the movable electrode 142, a movable extraction electrode 142A is formed so as to extend toward the periphery. Specifically, the movable extraction electrode 142A is provided in a position facing, of the pair of the extraction formation grooves formed in the fixed substrate 11, the other extraction formation groove in which the fixed extraction electrode 141A is not formed in the etalon planar view. Moreover, at the tip of the movable extraction electrode 142A, a movable electrode pad 142B is formed and is connected to the voltage control section.

### 2. Method for Producing an Etalon

Next, a method for producing the etalon 1 described above will be described based on the drawings.

### 2-1. Fixed Substrate (Second Substrate) Production Process

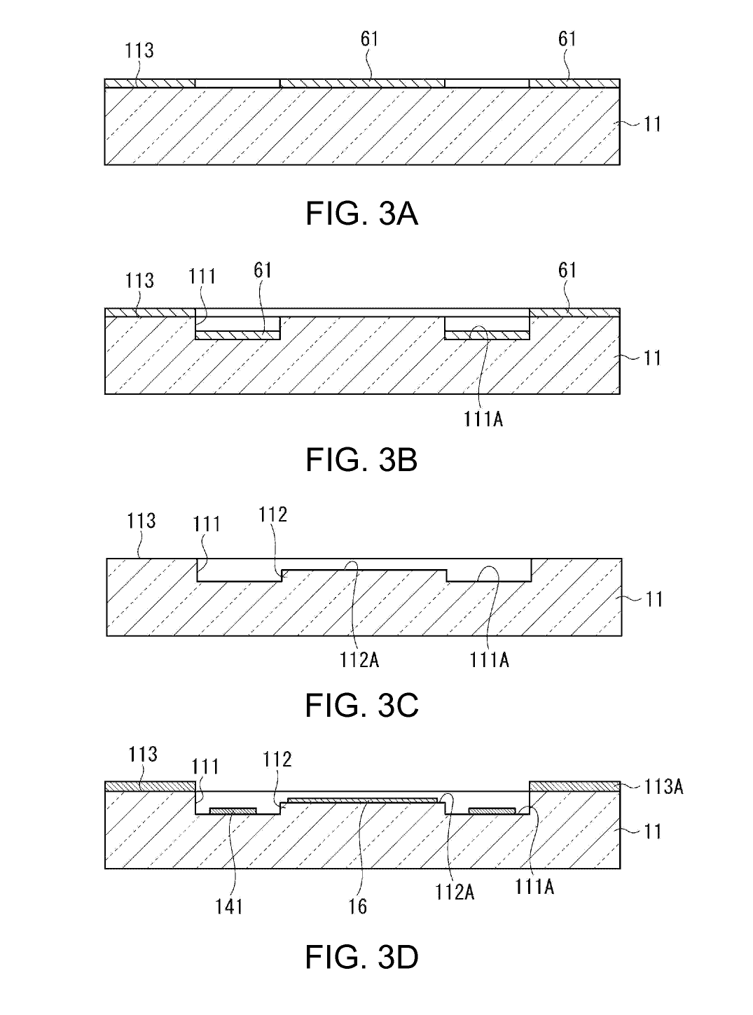

FIGS. 3A to 3D are diagrams showing the process for production of the fixed substrate 11 of the etalon 1.

First, a silica glass substrate which is a material for producing the fixed substrate 11 and has a thickness of 500 μm is prepared, and precision polishing is performed on both surfaces thereof until the surface roughness Ra of the silica glass substrate becomes 1 nm or less. Then, a resist 61 for formation of the electrode formation groove 111 is applied to a surface of the fixed substrate 11, the surface facing the movable substrate 12, and the resist 61 thus applied is exposed to light and developed by photolithography, whereby patterning is performed in an area in which the electrode formation groove 111 will be formed as shown in FIG. 3A.

Next, as shown in FIG. 3B, the electrode formation groove 111 is formed by etching so as to have an intended depth, and the electrode fixing surface 111A is formed. Incidentally, wet etching is used as etching performed in this process.

Then, the resist 61 for forming the reflection coating fixing surface 112A is applied to a surface of the fixed substrate 11, the surface facing the movable substrate 12, the resist 61 thus applied is exposed to light and developed by photolithography, and patterning is performed in an area in which the reflection coating fixing surface 112A will be formed as shown in FIG. 3B.

Next, as shown in FIG. 3C, the reflection coating fixing surface 112A is etched to an intended position and the resist 61 is then removed, whereby the electrode formation groove 111 and the reflection coating fixing section 112 are formed.

Then, as shown in FIG. 3D, the fixed reflection coating 16 is formed on the reflection coating fixing surface 112A, and the fixed electrode 141 (including the fixed extraction electrode 141A and the fixed electrode pad 141B) is formed in the electrode formation groove 111. Specifically, the fixed reflection coating 16 is formed by liftoff process. That is, a resist (a liftoff pattern) is formed by photolithography or the like in an area other than a reflection coating formation portion on the fixed substrate 11. Then, after the fixed reflection coating 16 is formed, the reflection coating in an area other than the reflection coating fixing surface 112A is removed by liftoff. Moreover, the fixed electrode 141, the fixed extraction electrode 141A, and the fixed electrode pad 141B are formed in intended positions by performing photolithography and etching on a film made of the material forming the electrode formed on the fixed substrate 11.

Furthermore, as shown in FIG. 3D, a first bonding film 113A is formed in the bonding section 113. The first bonding film 113A is a plasma-polymerized film formed by plasma CVD using polyorganosiloxane, and the thickness thereof is assumed to be 30 nm.

In this way, the fixed substrate 11 is produced.

### 2-2. Movable Substrate (First Substrate) Production Process

Next, a method for producing the movable substrate 12 will be described.

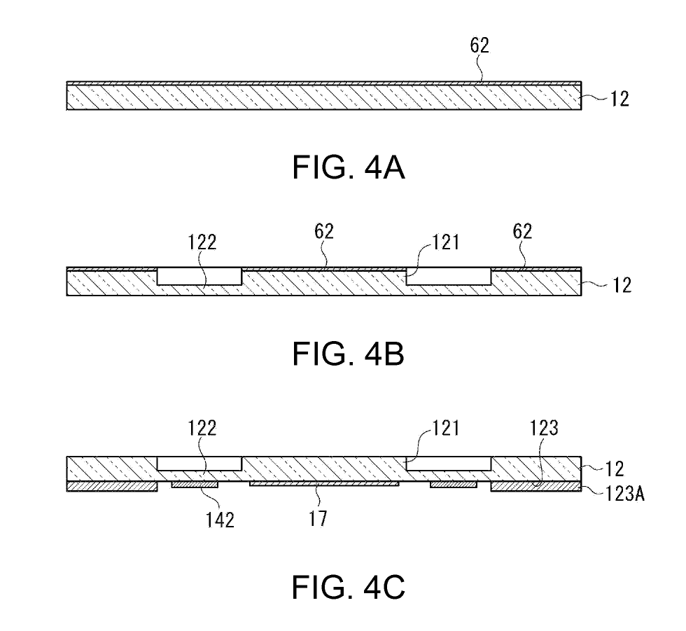

FIGS. 4A to 4C are sectional views showing an outline of the process for production of the movable substrate 12.

In the formation of the movable substrate 12, a base material (a glass substrate) which is a material for producing the movable substrate 12 is first prepared and is processed by cutting or the like so as to have a uniform thickness of 200 μm, for example. Then, the surface of the base material is processed by mirror-polishing to become a smooth surface whose average surface roughness Ra is 1 nm or less.

Next, as shown in FIG. 4A, a resist 62 is applied to one surface (a surface on the side of the movable substrate 12 opposite from a surface facing the fixed substrate 11) of the movable substrate 12.

Then, a resist pattern for forming the holding section 122 is formed by using photolithography, and wet etching is performed, whereby the movable section 121 and the holding section 122 shown in FIG. 4B are formed.

Then, as shown in FIG. 4C, the movable reflection coating 17 is formed in a position corresponding to the movable section 121 on the other surface (the surface facing the fixed substrate 11) of the movable substrate 12, and the movable electrode 142 (including the movable extraction electrode 142A and the movable electrode pad 142B) is formed in a position corresponding to the holding section 122. As is the case with the fixed reflection coating 16, the movable reflection coating 17 is formed by liftoff process. As is the case with the fixed electrode 141, the movable electrode 142, the movable extraction electrode 142A, and the movable electrode pad 142B are formed by photolithography and etching.

Furthermore, as shown in FIG. 4C, a second bonding film 123A is formed in the bonding section 123. The second bonding film 123A is a plasma-polymerized film formed by plasma CVD using polyorganosiloxane, and the thickness thereof is assumed to be 30 nm.

In this way, the movable substrate 12 is produced.

Here, when the movable reflection coating 17 and the movable electrode 142 are formed on the movable substrate 12, the movable substrate 12 bends due to the internal stress which acts on the movable reflection coating 17 and the movable electrode 142. Although the direction in which the movable substrate 12 bends differs depending on the materials forming the movable reflection coating 17 and the movable electrode 142, the direction in which the movable substrate 12 bends is a direction in which the movable substrate 12 gets closer to the fixed substrate 11 or a direction in which the movable substrate 12 moves away from the fixed substrate 11.

### 2-3. Bonding Process

Next, the substrates 11 and 12 formed in the above-described fixed substrate production process and movable substrate production process are bonded together by using a substrate bonding apparatus 2 provided with a lower plate 21 and an upper plate 22.

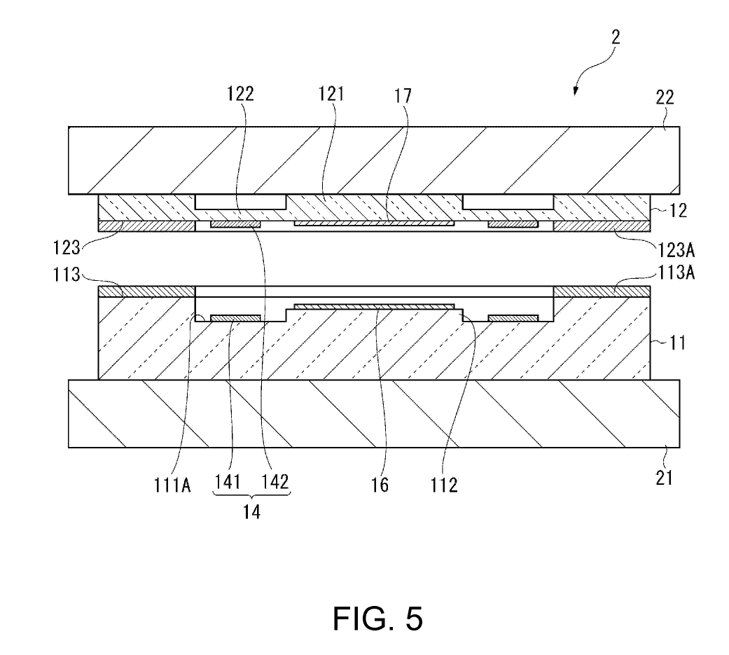

FIG. 5 is a sectional view showing an outline of a process for bonding the etalon 1.

In the substrate bonding apparatus 2, the lower plate 21 and the upper plate 22 vertically face each other and are disposed in such a way that they can get closer to each other and move away from each other.

The lower plate 21 has an unillustrated sucking unit, and makes a surface on the side of the fixed substrate 11 opposite from a surface on which the fixed reflection coating 16 and the like are formed stick to the lower plate 21 with the sucking unit and thereby holds that surface. Examples of the sucking unit include a plurality of holes formed on a sucking surface of the lower plate 21 so that the fixed substrate 11 is made to stick to the sucking surface by vacuum suction via these holes.

The upper plate 22 has an unillustrated heating unit such as a heater and an unillustrated sucking unit. The upper plate 22 makes a surface on the side of the movable substrate 12 opposite from a surface on which the movable reflection coating 17 and the like are formed stick to the upper plate 22 with the sucking unit, and heats the movable substrate 12 with the heating unit. A sucking unit similar to that of the lower plate 21 can be used.

As a result of being heated, the movable substrate 12 expands in a direction along the substrate surface. A temperature to which the movable substrate 12 is heated is appropriately set according to the thicknesses of the movable substrate 12 and the holding section 122, the direction and magnitude of the internal stress of the film thus formed, etc. so as to reduce bending after bonding. At this time, it is more preferable to heat the movable substrate 12 to such an extent that the movable reflection coating 17 formed on the movable substrate 12 does not deteriorate. For example, when the movable reflection coating 17 contains silver alloy, a temperature of the order of 150° C. is appropriate.

The bonding process is performed as follows.

First, the fixed substrate 11 is held by being sucked by the lower plate 21 and made to stick thereto. At this time, heating is not performed and the temperature is kept at room temperature.

Then, the movable substrate 12 is held by being sucked by the upper plate 22 and made to stick thereto, and is expanded by being heated to a predetermined temperature.

Next, O₂ plasma treatment or UV treatment is carried out to provide activation energy to the plasma-polymerized films forming the first bonding film 113A and the second bonding film 123A formed on the substrates 11 and 12, respectively. The O₂ plasma treatment is carried out for 30 seconds on conditions that the O₂ flow rate is 30 cc/minute, the pressure is 27 Pa, and the RF power is 200 W. Moreover, the UV treatment is carried out for 3 minutes by using excimer UV (wavelength: 172 nm) as a UV light source.

Then, as shown in FIG. 5, alignment of the fixed substrate 11 which is sucked by the lower plate 21 and made to stick thereto and the movable substrate 12 which is sucked by the upper plate 22 and made to stick thereto, the movable substrate 12 which is being heated, is performed so that the surface on which the movable reflection coating 17 is formed and the surface on which the fixed reflection coating 16 is formed face each other. The first bonding film 113A and the second bonding film 123A are then stacked, and a load is imposed on them, whereby the substrates 11 and 12 are bonded together. After the substrates 11 and 12 are bonded together, the temperature of the movable substrate 12 is restored to room temperature.

In this way, the etalon 1 is produced.

### 3. Effects of the First Embodiment

With the etalon 1 according to the first embodiment described above, the following effects can be obtained.

(1) After the movable substrate 12 which has bent during the movable substrate production process is heated in the bonding process, the fixed substrate 11 and the movable substrate 12 are bonded together. After the fixed substrate 11 and the movable substrate 12 are bonded together, when the temperature of the movable substrate 12 is restored to room temperature, the movable substrate 12 is about to contract in a direction along the substrate surface. However, since the movable substrate 12 is bonded to the fixed substrate 11 which has not been heated (which is at room temperature), the movable substrate 12 cannot contract in a direction along the substrate surface and is pulled in a direction along the substrate surface, whereby bending thereof is reduced. As a result, the etalon 1 in which bending of the movable substrate 12 is reduced is obtained.

This makes it possible to set the gap G between the fixed reflection coating 16 and the movable reflection coating 17 in an initial state with a high degree of accuracy, keep the fixed reflection coating 16 and the movable reflection coating 17 in a state in which they are parallel to each other with a high degree of accuracy, and improve the resolution of the etalon 1.

(2) In the etalon 1 produced by the production method described above, the thickness (500 μm) of the fixed substrate 11 is more than 1.5 times the thickness (200 μm) of the movable substrate 12. Therefore, the fixed substrate 11 has higher stiffness than the movable substrate 12. This makes it possible to prevent the warping of the entire etalon 1 by resisting the force by which the movable substrate 12 contracts in a direction along the substrate surface after the fixed substrate 11 and the movable substrate 12 are bonded together.

(3) In the production method described above, a method by which the movable substrate 12 which is being heated by the heating unit such as a heater and the fixed substrate 11 which is at room temperature are bonded together is adopted. This makes it easy to set the temperature of the movable substrate 12 so as to be higher than the temperature of the fixed substrate 11 and makes it possible to simplify the facilities to produce the etalon 1.

### Second Embodiment

Next, a second embodiment according to the invention will be described.

Incidentally, in the following description, the component elements which are the same as those of the first embodiment described above are identified with the same reference numerals, and their descriptions will be omitted.

The second embodiment differs from the first embodiment in the bonding process of the method for producing an etalon. In the first embodiment, the movable substrate 12 which is being heated and the fixed substrate 11 which is kept at room temperature are bonded together. On the other hand, in the second embodiment, the movable substrate 12 which is kept at room temperature and the fixed substrate 11 which is being cooled are bonded together.

Next, the fixed substrate 11 and the movable substrate 12 are bonded together by using a substrate bonding apparatus (hereinafter referred to as a second substrate bonding apparatus) according to the second embodiment. The second substrate bonding apparatus is the same as the substrate bonding apparatus 2 of the first embodiment except that the lower plate 21 has a cooling unit.

The bonding process is performed as follows.

First, the movable substrate 12 is held by being sucked by the upper plate 22 and made to stick thereto, the upper plate 22 of the second substrate bonding apparatus, at room temperature. On the other hand, the fixed substrate 11 is sucked by the lower plate 21 and made to stick thereto with the sucking unit of the lower plate 21, and the fixed substrate 11 is cooled by the cooling unit. The fixed substrate 11 contacts as a result of being cooled. As will be described later, in the second embodiment, bending of the movable substrate 12 is reduced by using expansion force generated when the temperature of the fixed substrate 11 is restored to room temperature after the fixed substrate 11 is made to contract by being cooled. Therefore, a temperature to which the fixed substrate 11 is cooled is appropriately set according to the thickness of the fixed substrate 11, the degree of bending of the movable substrate 12, and the like, such that bending of the movable substrate 12 is reduced.

Then, by performing bonding in the same manner as the first embodiment, an etalon according to the second embodiment is produced.

### Effects of the Second Embodiment

With the etalon according to the second embodiment described above, the following effects can be obtained.

(4) In the bonding process, the fixed substrate 11 and the movable substrate 12 are bonded together in a state in which the fixed substrate 11 is being cooled. After the fixed substrate 11 and the movable substrate 12 are bonded together, when the temperature of the fixed substrate 11 is restored to room temperature, the fixed substrate 11 is about to expand in a direction along the substrate surface. Here, since the fixed substrate 11 is thicker than the movable substrate 12, the expansion force acts also on the movable substrate 12 whose stiffness is lower than that of the fixed substrate 11 via the bonding sections 113 and 123. As a result, the movable substrate 12 is pulled in a direction along the substrate surface, and bending of the movable substrate 12 is reduced. In this way, an etalon in which bending of the movable substrate 12 is reduced is obtained.

As a result, it is possible to set the gap G between the fixed reflection coating 16 and the movable reflection coating 17 in an initial state with a high degree of accuracy, keep the fixed reflection coating 16 and the movable reflection coating 17 in a state in which they are parallel to each other with a high degree of accuracy, and improve the resolution of the etalon.

### MODIFIED EXAMPLES

It is to be understood that the invention is not limited in any way by the embodiments thereof described above, and, unless modifications and variations depart from the scope of the invention, they should be construed as being included therein.

The etalons according to the embodiments described above are used, for example, in a color measurement sensor of a color measurement device that analyzes and measures the color of an object to be tested.

In the embodiments described above, one substrate which is being heated or cooled and the other substrate which is kept at room temperature are bonded together; however, the invention is not limited thereto. For example, the movable substrate which is being heated and the fixed substrate which is being cooled may be bonded together.

Moreover, the configuration in which the gap G is adjusted is not limited to the configuration of the embodiments described above. For example, a configuration in which the gap interval between the fixed reflection coating 16 and the movable reflection coating 17 can be adjusted by placing, between the fixed substrate 11 and the movable substrate 12, a piezoelectric element that can expand and contract by the application of a voltage may be adopted.

In addition, in the bonding process, the movable substrate 12 may be heated in advance before the movable substrate 12 is sucked by the upper plate 22 and made to stick thereto and be then sucked by the upper plate 22 and made to stick thereto with the sucking unit, and the heat in the movable substrate 12 may be kept by the heating unit.

Moreover, in the substrate bonding apparatus 2, the heating unit may be provided in an area other than the upper plate 22, and, in the second substrate bonding apparatus, the cooling unit may be provided in an area other than the lower plate 21.

The entire disclosure of Japanese Patent Application No.2010-263249, filed Nov. 26, 2010 is expressly incorporated by reference herein.

What is claimed is:

1. A method for producing a tunable interference filter including a first substrate, a second substrate facing the first substrate, a first reflection coating provided on a first surface of the first substrate, the first surface facing the second substrate, a second reflection coating provided on a second surface of the second substrate, the second surface facing the first substrate, the second reflection coating facing the first reflection coating with a gap between the second reflection coating and the first reflection coating, and a gap changing section that can change the size of the gap, the gap changing section having a first gap changing section and a second first gap changing section, the first substrate having a movable section on which the first reflection coating is provided and a holding section having a thickness less than a thickness of the movable section, the holding section holding the movable section in such a way that the movable section can move with respect to the second substrate, the method comprising:
a first substrate production process of forming the first substrate and forming the first reflection coating and the first gap changing section on the first substrate;
a second substrate production process of forming the second substrate and forming the second reflection coating and the second gap changing section on the second substrate; and
a bonding process of bonding the first substrate and the second substrate in a state in which temperature of the first substrate is higher than temperature of the second substrate after the first substrate production process and the second substrate production process.

2. The method for producing a tunable interference filter according to claim 1, wherein
the bonding process is carried out in a state in which the first substrate is being heated and the second substrate is kept at room temperature.

3. The method for producing a tunable interference filter according to claim 1, wherein
a thickness of the second substrate is greater than a thickness of the first substrate.

4. The method for producing a tunable interference filter according to claim 1, wherein
the bonding process is carried out in a state in which the first substrate is kept at room temperature and the second substrate is being cooled.

5. The method for producing a tunable interference filter according to claim 1, wherein the first gap changing section includes a first electrode and the second gap changing section includes a second electrode.

6. The method for producing a tunable interference filter according to claim 1, wherein
the forming of the first substrate includes forming an electrode formation grove and forming a reflection coating fixing section, and
the forming of the second substrate includes forming the holding section.

7. A method for producing a tunable interference filter comprising bonding the first substrate and the second substrate, the first substrate having a first reflection coating and a first gap changing section, the second substrate having a second reflection coating and a second gap changing section, wherein the first substrate after the bonding is pulled in a direction along a surface of the first substrate.
